(19) United States
(12) Patent Application Publication
(10) Pub. No.: US 2017/0126723 A1
(43) Pub. Date: May 4, 2017

(54) METHOD AND DEVICE FOR IDENTIFYING URL LEGITIMACY

(71) Applicant: BAIDU ONLINE NETWORK TECHNOLOGY (BEIJING) CO., LTD., Beijing (CN)

(72) Inventors: Weiwei WANG, Beijing (CN); Cheng Peng, Beijing (CN); Qingwei Huang, Beijing (CN); Junhong Zhang, Beijing (CN); Xuefeng Luo, Beijing (CN)

(73) Assignee: BAIDU ONLINE NETWORK TECHNOLOGY (BEIJING) CO., LTD., Beijing (CN)

(21) Appl. No.: 15/275,303

(22) Filed: Sep. 23, 2016

(30) Foreign Application Priority Data
Oct. 30, 2015 (CN) 201510729115.9

(51) Int. Cl. H04L 29/06; G06F 17/27; G06F 7/02

(52) U.S. Cl. CPC H04L 63/1425; G06F 7/02; G06F 17/2705

(57) ABSTRACT

The present invention provides a method and device for identifying URL legitimacy. Through obtaining a URL to be identified, and then obtaining, based on the URL to be identified, a legitimate URL corresponding to the URL to be identified as a comparison object, and calculating a degree of similarity between the URL to be identified and the comparison object, the present invention makes it possible to identify the legitimacy of the URL to be identified based on the degree of similarity, enabling timely discovering of illegitimate URLs and thus improving the safety of information processing.

### TECHNICAL FIELD

The present invention relates to safety technology, and more particularly to a method and device for identifying URL legitimacy.

### BACKGROUND

With the development of communication technology, more and more functions are integrated into a terminal, so that the system function list of the terminal contains an increasing number of corresponding applications (APP). Some Apps involve the function of receiving pre-edited information from a sender, for example, SMS, MMS, or e-mail. The information may contain a Uniform Resource Locator (URL) of an object, the terminal can directly execute corresponding operations based on the URL. The operations can be, for example, accessing the corresponding target object of the URL, or for another example, accessing the corresponding target object of the URL based on the operation information of the user clicking the URL.

Nevertheless, because the information is generated randomly, villains can easily write unsafe objects such as viruses, Trojan horses, and other implant information, into the information, i.e., write URLs of unsafe objects in the information, and therefore, after obtaining the URLs contained in the information, the terminal may the visit unsafe objects, which makes the terminal and the user subject to different degrees of damage, resulting in reduced information processing safety.

### SUMMARY

Aspects of the present invention provide a method and device for identifying URL legitimacy to improve safety of information processing.

One aspect of the present invention provides a method for identifying URL legitimacy, comprising:

obtaining a URL to be identified,

obtaining, based on the URL to be identified, a legitimate URL corresponding to the URL to be identified as a comparison object;

calculating a degree of similarity between the URL to be identified and the comparison object;

identifying the legitimacy of the URL to be identified based on the degree of similarity.

As the above aspect and in any possible way of information, a way of implementation is further provided, the step of obtaining, based on the URL to be identified, a legitimate URL corresponding to the URL to be identified as a comparison object comprises:

obtaining, based on the URL to be identified and an inverted index of legitimate URLs, a legitimate URL corresponding to the URL to be identified as the comparison object.

As the above aspect and in any possible way of information, a way of implementation is further provided, the method comprises, before the step of obtaining, based on the URL to be identified and an inverted index of legitimate URLs, a legitimate URL corresponding to the URL to be identified as the comparison object, the following:

collecting at least one legitimate URL;

carrying out word segmentation on each of the legitimate URLs of the at least one legitimate URL with a N-Gram model, so as to obtain a segmentation result;

obtaining the inverted index of legitimate URLs based on each of the legitimate URLs and the segmentation result of each of the legitimate URLs.

As the above aspect and in any possible way of information, a way of implementation is further provided, the step of carrying out a word segmentation on each of the legitimate URLs of the at least one legitimate URL with a N-Gram model, so as to obtain a segmentation result comprises:

obtaining the domain name of each of the legitimate URLs based each of the legitimate URLs;

removing the prefix and suffix of the domain name of each of the legitimate URLs, so as to obtain an essential word of each of the legitimate URLs;

carrying out word segmentation on the essential word of each of the legitimate URLs with a N-Gram model, so as to obtain a segmentation result.

As the above aspect and in any possible way of information, a way of implementation is further provided, the step of identifying the legitimacy of the URL to be identified based on the degree of similarity comprises:

identifying the URL to be identified as a legitimate URL if the degree of similarity is equal to 1 and the suffix of the URL to be identified is consistent with the suffix of the comparison object; or

identifying the URL to be identified as a suspected illegitimate URL if the degree of similarity is equal to 1 and the suffix of the URL to be identified is inconsistent with the suffix of the comparison object; or

identifying the URL to be identified as an illegitimate URL if the degree of similarity is greater than or equal to a first threshold value and less than 1;

identifying the URL to be identified as a suspected illegitimate URL if the degree of similarity is greater than or equal to a second threshold value and less than the first threshold value, wherein the second threshold value is less than the first threshold value;

identifying the URL to be identified as a legitimate URL if the degree of similarity is less than the second threshold value or equal to 1.

As the above aspect and in any possible way of information, a way of implementation is further provided, before the step of identifying the legitimacy of the URL to be identified based on the degree of similarity, the method further comprises:

carrying out legitimacy identification processing on at least one sample URL with the at least one legitimate URL, so as to obtain an identification result;

obtaining the first threshold value and the second threshold value based on the identification result and a labeling result of each of the sample URLs of the at least one sample URL.

As the above aspect and in any possible way of information, a way of implementation is further provided, after the step of identifying the legitimacy of the URL to be identified based on the degree of similarity, the method further comprises:

sending the identification result to a terminal so that:
the terminal displays the identification result; and/or
the terminal allows or prohibits, based on the identification result, executing access operations based on the URL to be identified.

Another aspect of the present inventions provides a device for identifying URL legitimacy comprising:

an acquisition unit for obtaining a URL to be identified;

a matching unit for obtaining, based on the URL to be identified, a legitimate URL corresponding to the URL to be identified as a comparison object;

a calculating unit for calculating a degree of similarity between the URL to be identified and the comparison object;

an identification unit for identifying the legitimacy of the URL to be identified based on the degree of similarity.

As the above aspect and in any possible way of information, a way of implementation is further provided, the matching unit is specifically used for:

obtaining, based on the URL to be identified and an inverted index of legitimate URLs, a legitimate URL corresponding to the URL to be identified as the comparison object.

As the above aspect and in any possible way of information, a way of implementation is further provided, the device further comprises a pre-processing unit, used for:

collecting at least one legitimate URL;

carry out word segmentation on each of the legitimate URLs of the at least one legitimate URL with a N-Gram model, so as to obtain a segmentation result;

obtaining the inverted index of legitimate URLs based on each of the legitimate URLs and the segmentation result of each of the legitimate URLs.

As the above aspect and in any possible way of information, a way of implementation is further provided, the pre-processing unit is specifically used for:

obtaining the domain name of each of the legitimate URLs based each of the legitimate URLs;

removing the prefix and suffix of the domain name of each of the legitimate URLs, so as to obtain an essential word of each of the legitimate URLs;

carrying out word segmentation on the essential word of each of the legitimate URLs with a N-Gram model, so as to obtain a segmentation result.

As the above aspect and in any possible way of information, a way of implementation is further provided, the identifying unit is specifically used for:

identifying the URL to be identified as a legitimate URL if the degree of similarity is equal to 1 and the suffix of the URL to be identified is consistent with the suffix of the comparison object; or

identifying the URL to be identified as a suspected illegitimate URL if the degree of similarity is equal to 1 and the suffix of the URL to be identified is inconsistent with the suffix of the comparison object; or

identifying the URL to be identified as an illegitimate URL if the degree of similarity is greater than or equal to a first threshold value and less than 1;

identifying the URL to be identified as a suspected illegitimate URL if the degree of similarity is greater than or equal to a second threshold value and less than the first threshold value, wherein the second threshold value is less than the first threshold value;

identifying the URL to be identified as a legitimate URL if the degree of similarity is less than the second threshold value or equal to 1.

As the above aspect and in any possible way of information, a way of implementation is further provided, the identifying unit is further used for:

carrying out legitimacy identification processing on at least one sample URL with the at least one legitimate URL, so as to obtain an identification result;

obtaining the first threshold value and the second threshold value based on the identification result and a labeling result of each of the sample URLs of the at least one sample URL.

As the above aspect and in any possible way of information, a way of implementation is further provided, the identifying unit is further used for:

sending the identification result to a terminal so that:
the terminal displays the identification result; and/or
the terminal allows or prohibits, based on the identification result, executing access operations based on the URL to be identified.

Another aspect of the present invention provides an apparatus, comprising:

one or more processors;
a memory;
one or more programs, which are stored in the memory, and execute the following when executed by the one or more processors:
obtaining a URL to be identified,

obtaining, based on the URL to be identified, a legitimate URL corresponding to the URL to be identified as a comparison object;

calculating a degree of similarity between the URL to be identified and the comparison object;

identifying the legitimacy of the URL to be identified based on the degree of similarity.

Another aspect of the present invention provides a nonvolatile computer storage medium, stored with one or more programs, which, when executed by an apparatus, make the apparatus to execute the following:

obtaining a URL to be identified,

obtaining, based on the URL to be identified, a legitimate URL corresponding to the URL to be identified as a comparison object;

calculating a degree of similarity between the URL to be identified and the comparison object;

identifying the legitimacy of the URL to be identified based on the degree of similarity.

As can be seen from the above technical solutions, in the embodiments of the present invention, through obtaining a URL to be identified, and then obtaining, based on the URL to be identified, a legitimate URL corresponding to the URL to be identified as a comparison object, and calculating a degree of similarity between the URL to be identified and the comparison object, it is possible to identify the legitimacy of the URL to be identified based on the degree of similarity, enabling timely discovering of illegitimate URLs and thus improving the safety of information processing.

In addition, with the technical solutions provided by the invention, it is not necessary to do content-based identification on the corresponding content of the URL to be identified, thereby improving information processing efficiency and real-time capability.

In addition, with the technical solutions provided by the invention, it is not necessary to do content-based identification on the corresponding content of the URL to be identified, thereby effectively reducing required processing resources for identification and reducing the processing load.

In addition, with the technical solutions provided by the invention, due to sending the result of identifying the legitimacy of the URL to be identified to a terminal to instruct the terminal to allow or prohibit executing accessing operations according to the URL to be identified, it is possible to further improve the safety of information processing.

### BRIEF DESCRIPTION OF DRAWINGS

In order to more clearly illustrate the technical solutions in the embodiments of the present invention, the drawings used for description of the embodiments or prior art will be briefly described; as is obvious, the drawings described below refer to some embodiments of the invention, those of ordinary skills can, without creative efforts, also obtain other drawings based on these drawings.

FIG. 1 is a schematic flowchart of a method for identifying URL legitimacy of one embodiment of the invention;

FIG. 2 is a schematic structure view of a device for identifying URL legitimacy of another embodiment of the invention;

FIG. 3 is a schematic structure view of a device for identifying URL legitimacy of another embodiment of the invention.

### DETAILED DESCRIPTION

To show the object, technical solutions, and advantages of the embodiments of the invention more clearly, the technical solutions of the embodiments of the present invention will be described fully and clearly below in conjunction with the drawings of the embodiment of the invention. It is clear that the described embodiments are only part, not all, of the embodiments of the present invention. Based on the embodiments of the present invention, all other embodiments made by one of ordinary skill in the art without creative labor are within the protection scope of the present invention.

It should be noted that terminals involved in the embodiments of the present invention may include, but are not limited to, cell phones, personal digital assistants (PDA), wireless handheld devices, tablet computers, personal computers (PC), MP3 players, MP4 players, wearable devices (for example, smart glasses, smart watches, smart bracelet, etc.).

In addition, the term “and/or” is merely a description of the associated relationship of associated objects, indicating that three kinds of relationship can exist, for example, A and/or B, can be expressed as: the presence of A alone, presence of both A and B, presence of B alone. In addition, the character “/” generally represents an “OR” relationship between the associated objects before and after the character.

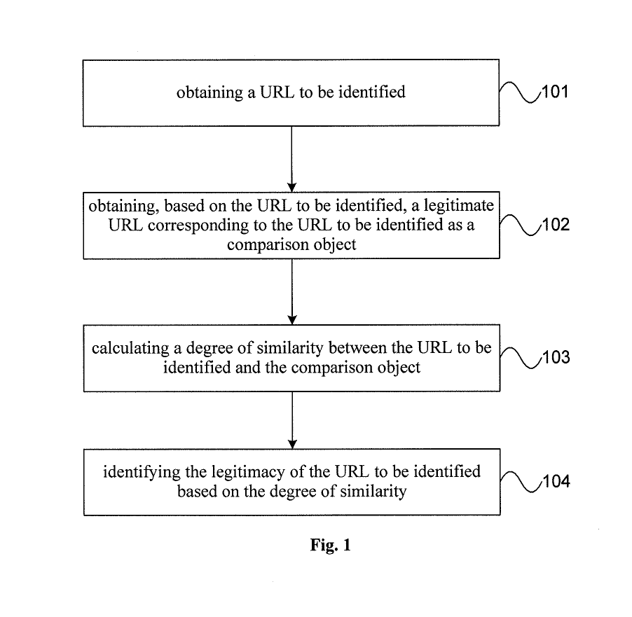

FIG. 1 is a schematic flowchart of a method for identifying URL legitimacy according to one embodiment of the present invention, as shown in FIG. 1.

101, obtaining a URL to be identified;

102, obtaining, based on the URL to be identified, a legitimate URL corresponding to the URL to be identified as a comparison object;

103, calculating a degree of similarity between the URL to be identified and the comparison object;

104, identifying the legitimacy of the URL to be identified based on the degree of similarity.

It should be noted that part or all of the executive agent of 101 to 104 can be an App located in a local terminal, a functional unit such as a plug-in or software development kit (SDK) disposed in an App located in a local terminal, a processing engine in a network server, or a distributed system in a network. The present embodiment is not particularly limited to the aforementioned.

As can be understood, the App can be a native App installed locally in a terminal, or a web App of a browser in a terminal. The present embodiment is not particularly limited.

In this way, through obtaining a URL to be identified, and then obtaining, based on the URL to be identified, a legitimate URL corresponding to the URL to be identified as a comparison object, and calculating a degree of similarity between the URL to be identified and the comparison object, it is possible to identify the legitimacy of the URL to be identified based on the degree of similarity, enabling timely discovering of illegitimate URLs and thus improving the safety of information processing.

Alternatively, in a possible implementation of the present embodiment, in 101, one can specifically obtain target information received by a terminal, the target information includes the URL to be identified.

Herein, the target information may include, but is not limited to, SMS (short message service), MMS (multimedia message service), or e-mail. The present embodiment is not particularly limited. In particular, detailed description of SMS, MMS and e-mail can be found in related content in the prior art, whose details will not be mentioned here.

In general, a SMS, MMS, or e-mail message can contain any content, such as text, image, or URL. Such information can be directly sent to the terminal of a user with existing communication techniques, such as pseudo base stations and other communications technology, which also avoids safety audit by an application distribution platform. Accordingly, once the content of the information encounters safety problems, the terminal and the user will be subject to different degrees of damage.

In this embodiment, only information containing URLs will be obtained as the target information, other information is not within the scope of the present invention.

As should be noted, the URL can be directly included in the information, for example, included in the information in the form of plain text content, or included in the information indirectly, for example, in the form of a bar code. The present embodiment is not particularly limited. Herein, the bar code information may be, but is not limited to, one-dimensional bar codes or two-dimensional bar code. This embodiment is not particularly limited. Specifically, detailed description of one-dimensional bar code and two-dimensional bar code can be found in related content in the prior art, whose details will not be mentioned here.

As can be understood, details regarding scanning a bar code and then using a decode function to decode the scanned information so as to obtain the URL included in the bar code can be found in related content in the prior art, whose details will not be mentioned here.

In a specific implementation, the URL included in the obtained target information may be, but is not limited to, access address of a world wide web page or download address of a file, for example, a link started with http or https, etc. The present embodiment is not particularly limited.

Herein, the file may include, but is not limited to, at least one of text file, image file, video file, and installation file. The present embodiment is not particularly limited.

Herein the installation file can be Android Package Kit (APK), or installation package kit for other applications, such as the kit for IOS operating system application. This embodiment is not particularly limited.

Alternatively, in a possible implementation of the present embodiment, in 102, one can specifically obtain, based on the URL to be identified and an inverted index of legitimate URLs, a legitimate URL corresponding to the URL to be identified as the comparison object. This can effectively improve retrieval efficiency.

In a specific implementation, before executing 102, an inverted index of legitimate URLs that serves as the base need to be established.

Specifically, one can collect at least one legitimate URL, for example, URLs of websites of telecom operators, or for another example, URLs of bank websites such as www.icbc.com.cn. Then, one can carry out word segmentation on each of the legitimate URLs of the at least one legitimate URL with a N-Gram model (N is greater than or equal to 2), so as to obtain a segmentation result. Next, one can obtain the inverted index of legitimate URLs based on each of the legitimate URLs and the segmentation result of each of the legitimate URLs.

The way to use a N-Gram model for a specific implementation can be: obtaining the domain name of each of the legitimate URLs based each of the legitimate URLs; removing the prefix and suffix of the domain name of each of the legitimate URLs, so as to obtain an essential word of each of the legitimate URLs; carrying out word segmentation on the essential word of each of the legitimate URLs with a N-Gram model, so as to obtain a segmentation result.

For example, one can use a N-Gram model to select, from the collected essential word of the URL, a content feature as the segmentation result. For example, one can select, from essential word icbc of the legitimate URL, a binary feature such as ic, cb, and bc; or, for another example, one can select, from the essential word icbc of the legitimate URL, a ternary feature such as icb and cbc; or, for another example, one can select, from the essential word icbc of the legitimate URL, a quaternary feature such as icbc. This embodiment is not particularly limited. In particular, detailed description of the N-gram model can be found in related content in the prior art, whose details will not be mentioned here.

Alternatively, in a possible implementation of the present embodiment, in 103, one can specifically use the method of minimum edit distance to obtain the degree of similarity between the URL to be identified and the comparison object. Specifically, one can take the minimum edit distance between the URL to be identified and the comparison object as the calculation function for the degree of similarity between the URL to be identified and the comparison object.

The so-called edit distance, also known as Levenshtein distance, is related to two strings, referring to the minimum number of editing operations to transform one string into another. Herein, the editing operations may include, but are not limited to, at least one of replacing one character with another, inserting one character, and deleting one character. The present embodiment is not particularly limited. In general, the smaller the edit distance is, the greater the degree of similarity between two strings is.

Specifically, one can obtain the domain name of each of the legitimate URLs based each of the legitimate URLs; remove the prefix and suffix of the domain name of each of the legitimate URLs, so as to obtain an essential word of each of the legitimate URLs; and carry out word segmentation on the essential word of each of the legitimate URLs with a N-Gram model, so as to obtain a segmentation result.

Alternatively, in a possible implementation of the present embodiment, in 104, one can specifically execute the following: identifying the URL to be identified as a legitimate URL if the degree of similarity is equal to 1 and the suffix of the URL to be identified is consistent with the suffix of the comparison object; or identifying the URL to be identified as a suspected illegitimate URL if the degree of similarity is equal to 1 and the suffix of the URL to be identified is inconsistent with the suffix of the comparison object; or identifying the URL to be identified as an illegitimate URL if the degree of similarity is greater than or equal to a first threshold value and less than 1; identifying the URL to be identified as a suspected illegitimate URL if the degree of similarity is greater than or equal to a second threshold value and less than the first threshold value, wherein the second threshold value is less than the first threshold value; identifying the URL to be identified as a legitimate URL if the degree of similarity is less than the second threshold value or equal to 1.

Herein, the first threshold value and the second threshold value can be empiric values, or values determined by a classifier built through training with some sample URLs. The present embodiment is not particularly limited.

After building a classifier, one can carry out legitimacy identification processing on at least one sample URL with the at least one legitimate URL, so as to obtain an identification result; and then adjust parameters of the classifier based on the identification result and a labeling result of each of the sample URLs of the at least one sample URL, so as to obtain the first threshold value and the second threshold value. For example, one can design penalty function “cost” as follows:

cost=fp_cost*fp_count+fn_cost*fn_count+unsure_cost*unsure_count;

wherein,

fp_cost=10, fp_count represents the number of times an illegitimate URL is identified as a legitimate URL;

fn_cost=6, fn_count represents the number of times a legitimate URL is identified as a legitimate URL;

unsure_cost=6, unsure_count represents the number of times a URL is identified as a suspected illegitimate URL.

The classifier parameters obtained by minimizing the penalty function can be used as the final first threshold value and second threshold value to be applied to identification.

As should be noted, URLs in a sample URL set can be known samples that have been already labeled, so that it is possible to directly use the known samples for training to build the classifier, or, a portion of the samples are labeled known samples, while another portion are unlabeled unknown samples; in this case, the known samples can be used for training to build an initial classifier, which is then used to predict the unknown samples so as to obtain a classification result, the classification result of the unknown samples is then used to label the unknown samples so as to form known samples as newly added known samples, which, as well as the original known samples, are used for re-training, so as to obtain a new classifier, until the built classifier or the known samples meet the cut-off condition of the target classifier. The cut-off condition can be, for example, the accuracy of the classification is greater than or equal to a preset threshold value, or the number of known samples is greater than or equal to a preset threshold number. The embodiment is not particularly limited.

Alternatively, in a possible implementation of the present embodiment, after 104, one can further send the identification result to a terminal. Herein, the terminal can be the one that obtains the URL to be identified, or any registered terminal, the present embodiment is not particularly limited. In this way, the terminal can execute operations based on the identification result.

For example, the terminal may further display the identification result, so as to prompt the safety of the URL to be identified. Specifically, one can use at least one of tags, bubbles, pop-ups, drop-down menus, and voice to show the identification result. In this way, through the terminal showing the identification result, it is possible to allow the terminal user to decide, based on the identification result, whether to continue to access the corresponding content of the URL to be identified.

Or, for another example, the terminal can further allow or prohibit, based on the identification result, executing accessing operations according to the URL to be identified.

In this way, due to sending the result of identifying the legitimacy of the URL to be identified to a terminal to instruct the terminal to allow or prohibit executing accessing operations according to the URL to be identified, it is possible to further improve the safety of information processing.

In this embodiment, through obtaining a URL to be identified, and then obtaining, based on the URL to be identified, a legitimate URL corresponding to the URL to be identified as a comparison object, and calculating a degree of similarity between the URL to be identified and the comparison object, it is possible to identify the legitimacy of the URL to be identified based on the degree of similarity, enabling timely discovering of illegitimate URLs and thus improving the safety of information processing.

In addition, with the technical solutions provided by the invention, it is not necessary to do content-based identification on the corresponding content of the URL to be identified, thereby improving information processing efficiency and real-time capability.

In addition, with the technical solutions provided by the invention, it is not necessary to do content-based identification on the corresponding content of the URL to be identified, thereby effectively reducing required processing resources for identification and reducing the processing load.

In addition, with the technical solutions provided by the invention, due to sending the result of identifying the legitimacy of the URL to be identified to a terminal to instruct the terminal to allow or prohibit executing accessing operations according to the URL to be identified, it is possible to further improve the safety of information processing.

As should be noted, for the sake of simple description, each of the aforementioned embodiments of the method is described as a combination of a series of actions. Those skilled in the art, however, should be aware that the present invention is not limited to the orders of actions as described, because according to the present invention, some steps may employ other sequences or be carried out simultaneously. Secondly, those skilled in the art will also be aware that the embodiments described in the specification belong to preferred embodiments, the involved actions and modules are not necessarily a must for the present invention.

In the above embodiments, the descriptions of the various embodiments have different emphases, a part not included in a certain embodiment can be found in other described embodiments.

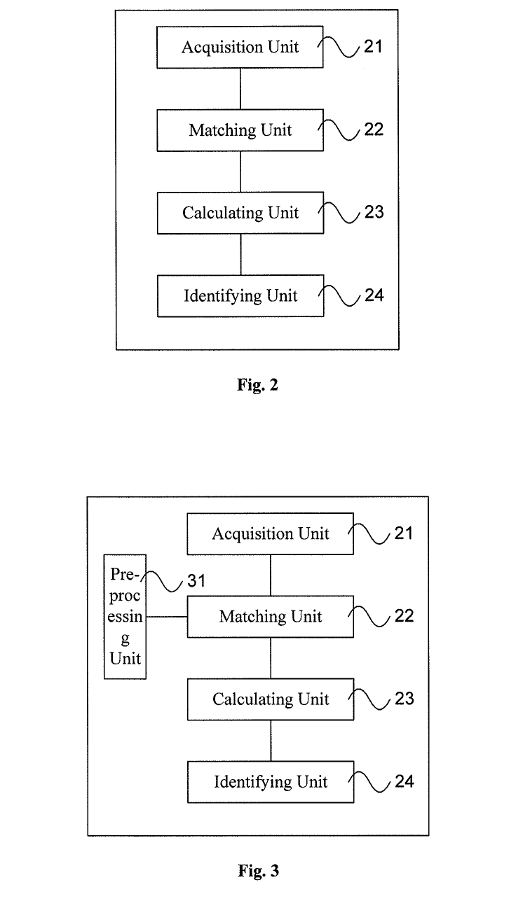

FIG. 2 is a schematic structure view of a device for identifying URL legitimacy according to another embodiment of the present invention, as shown in FIG. 2. The device for identifying URL legitimacy of the embodiment may comprise an acquisition unit 21, a matching unit 22, a calculating unit 23, and an identification unit 24. Herein, the acquisition unit 21 is used for obtaining a URL to be identified; the matching unit 22 is used for obtaining, based on the URL to be identified, a legitimate URL corresponding to the URL to be identified as a comparison object; the calculating unit 23 is used for calculating a degree of similarity between the URL to be identified and the comparison object; the identification unit 24 is used for identifying the legitimacy of the URL to be identified based on the degree of similarity.

It should be noted that a part of or the entire device for identifying URL legitimacy of the present embodiment can be an App located in a local terminal, a functional unit such as a plug-in or software development kit (SDK) disposed in an App located in a local terminal, a processing engine in a network server, or a distributed system in a network, the present embodiment is not particularly limited.

As can be understood, the App can be a native App installed locally in a terminal, or it can also be a web App of a browser in a terminal. The present embodiment is not particularly limited.

Alternatively, in a possible implementation of the embodiment, the matching unit 22 can be specifically used for: obtaining, based on the URL to be identified and an inverted index of legitimate URLs, a legitimate URL corresponding to the URL to be identified as the comparison object.

Alternatively, in a possible implementation of the embodiment, as shown in FIG. 3, the device for identifying URL legitimacy of the embodiment can further comprise a pre-processing unit 31, the pre-processing unit can be used for: collecting at least one legitimate URL; carrying out word segmentation on each of the legitimate URLs of the at least one legitimate URL with a N-Gram model, so as to obtain a segmentation result; obtaining the inverted index of legitimate URLs based on each of the legitimate URLs and the segmentation result of each of the legitimate URLs.

In a possible implementation, the pre-processing unit 31 can be specifically used for: obtaining the domain name of each of the legitimate URLs based each of the legitimate URLs; removing the prefix and suffix of the domain name of each of the legitimate URLs, so as to obtain an essential word of each of the legitimate URLs; carrying out word segmentation on the essential word of each of the legitimate URLs with a N-Gram model, so as to obtain the segmentation result.

Alternatively, in a possible implementation of the embodiment, the identifying unit 24 can be specifically used for: identifying the URL to be identified as a legitimate URL if the degree of similarity is equal to 1 and the suffix of the URL to be identified is consistent with the suffix of the comparison object; or identifying the URL to be identified as a suspected illegitimate URL if the degree of similarity is equal to 1 and the suffix of the URL to be identified is inconsistent with the suffix of the comparison object; or identifying the URL to be identified as an illegitimate URL if the degree of similarity is greater than or equal to a first threshold value and less than 1; identifying the URL to be identified as a suspected illegitimate URL if the degree of similarity is greater than or equal to a second threshold value and less than the first threshold value, wherein the second threshold value is less than the first threshold value; identifying the URL to be identified as a legitimate URL if the degree of similarity is less than the second threshold value or equal to 1.

Alternatively, in a possible implementation of the embodiment, the identifying unit 24 can be further used for: carrying out legitimacy identification processing on at least one sample URL with the at least one legitimate URL, so as to obtain an identification result; obtaining the first threshold value and the second threshold value based on the identification result and a labeling result of each of the sample URLs of the at least one sample URL.

Alternatively, in a possible implementation of the embodiment, the identifying unit 24 can be further used for: sending the identification result to a terminal so that: the terminal displays the identification result; and/or the terminal allows or prohibits, based on the identification result, executing access operations based on the URL to be identified.

As should be noted, the method of the embodiment of FIG. 1 can be implemented by the device for identifying URL legitimacy provided in this embodiment. Detailed description can be found in related resources with references to FIG. 1, whose description will not be repeated here.

In this embodiment, through obtaining a URL to be identified by an acquisition unit, and then obtaining, by a matching unit and based on the URL to be identified, a legitimate URL corresponding to the URL to be identified as a comparison object, and calculating, by a calculating unit, a degree of similarity between the URL to be identified and the comparison object, it is possible for an identification unit to identify the legitimacy of the URL to be identified based on the degree of similarity, enabling timely discovering of illegitimate URLs and thus improving the safety of information processing.

In addition, with the technical solutions provided by the invention, it is not necessary to do content-based identification on the corresponding content of the URL to be identified, thereby improving information processing efficiency and real-time capability.

In addition, with the technical solutions provided by the invention, it is not necessary to do content-based identification on the corresponding content of the URL to be identified, thereby effectively reducing required processing resources for identification and reducing the processing load.

In addition, with the technical solutions provided by the invention, due to sending the result of identifying the legitimacy of the URL to be identified to the terminal to instruct the terminal to allow or prohibit executing accessing operations according to the URL to be identified, it is possible to further improve the safety of information processing.

Those skilled in the art can clearly understand that, for convenience and simplicity of description, the specific working processes of the aforementioned systems, devices, and units can be understood with references to the corresponding processes of the above embodiments, whose detailed description will not be repeated here.

As should be understood, in the various embodiments of the present invention, the disclosed systems, devices, and methods can be implemented through other ways. For example, the embodiments of the devices described above are merely illustrative. For example, the division of the units is only a logical functional division, the division may be done in other ways in actual implementations, for example, a plurality of units or components may be combined or be integrated into another system, or some features may be ignored or not implemented. Additionally, the displayed or discussed coupling or direct coupling or communicating connection between one and another may be indirect coupling or communicating connection through some interface, device, or unit, which can be electrical, mechanical, or of any other forms.

The units described as separate members may be or may be not physically separated, the components shown as units may or may not be physical units, which can be located in one place, or distributed in a number of network units. One can select some or all of the units to achieve the purpose of the embodiments according to the embodiment of the actual needs.

Further, in the embodiment of the present invention, the functional units in each embodiment may be integrated in a processing unit, or each unit may be a separate physical existence, or two or more units can be integrated in one unit. The integrated units described above can be used both in the form of hardware, or in the form of software plus hardware.

The aforementioned integrated unit implemented in the form of software may be stored in a computer readable storage medium. Said functional units of software are stored in a storage medium, including a number of instructions to instruct a computer device (it may be a personal computer, server, or network equipment, etc.) or processor to perform some steps of the method described in various embodiments of the present invention. The aforementioned storage medium includes: U disk, removable hard disk, read-only memory (ROM), a random access memory (RAM), magnetic disk, or an optical disk medium may store program code.

Finally, as should be noted, the above embodiments are merely provided for describing the technical solutions of the present invention, not intended to limit them; although references to the embodiments of the present invention have been made to describe the details of the present invention, those skilled in the art will appreciate: one can still make changes on the technical solutions described in the various embodiments, or make equivalent replacements to some technical features; and such modifications or replacements do not make the essence of corresponding technical solutions depart from the spirit and scope of embodiments of the present invention.

We claim:

1. A method for identifying URL legitimacy, wherein the method comprises:
obtaining a URL to be identified;
obtaining, based on the URL to be identified, a legitimate URL corresponding to the URL to be identified as a comparison object;
calculating a degree of similarity between the URL to be identified and the comparison object;
identifying the legitimacy of the URL to be identified based on the degree of similarity.

2. The method according to claim 1, wherein the step of obtaining, based on the URL to be identified, a legitimate URL corresponding to the URL to be identified as a comparison object comprises:
obtaining, based on the URL to be identified and an inverted index of legitimate URLs, a legitimate URL corresponding to the URL to be identified as the comparison object.

3. The method according to claim 2, wherein, the method comprises, before the step of obtaining, based on the URL to be identified and an inverted index of legitimate URLs, a legitimate URL corresponding to the URL to be identified as the comparison object, the following:
collecting at least one legitimate URL;
carrying out word segmentation on each of the legitimate URLs of the at least one legitimate URL with a N-Gram model, so as to obtain a segmentation result;
obtaining the inverted index of legitimate URLs based on each of the legitimate URLs and the segmentation result of each of the legitimate URLs.

4. The method according to claim 3, wherein, the step of carrying out a word segmentation on each of the legitimate URLs of the at least one legitimate URL with a N-Gram model, so as to obtain a segmentation result comprises:
obtaining the domain name of each of the legitimate URLs based each of the legitimate URLs;
removing the prefix and suffix of the domain name of each of the legitimate URLs, so as to obtain an essential word of each of the legitimate URLs;
carrying out word segmentation on the essential word of each of the legitimate URLs with a N-Gram model, so as to obtain a segmentation result.

5. The method according to claim 1, wherein, the step of identifying the legitimacy of the URL to be identified based on the degree of similarity comprises:
identifying the URL to be identified as a legitimate URL if the degree of similarity is equal to 1 and the suffix of the URL to be identified is consistent with the suffix of the comparison object; or
identifying the URL to be identified as a suspected illegitimate URL if the degree of similarity is equal to 1 and the suffix of the URL to be identified is inconsistent with the suffix of the comparison object; or
identifying the URL to be identified as an illegitimate URL if the degree of similarity is greater than or equal to a first threshold value and less than 1;
identifying the URL to be identified as a suspected illegitimate URL if the degree of similarity is greater than or equal to a second threshold value and less than the first threshold value, wherein the second threshold value is less than the first threshold value;
identifying the URL to be identified as a legitimate URL if the degree of similarity is less than the second threshold value or equal to 1.

6. The method according to claim 5, wherein, before the step of identifying the legitimacy of the URL to be identified based on the degree of similarity, the method further comprises:
carrying out legitimacy identification processing on at least one sample URL with the at least one legitimate URL, so as to obtain an identification result;
obtaining the first threshold value and the second threshold value based on the identification result and a labeling result of each of the sample URLs of the at least one sample URL.

7. The method according to claim 1, wherein after the step of identifying the legitimacy of the URL to be identified based on the degree of similarity, the method further comprises:
sending the identification result to a terminal so that:
the terminal displays the identification result; and/or
the terminal allows or prohibits, based on the identification result, executing access operations based on the URL to be identified.

8. A nonvolatile computer storage medium, stored with one or more programs, which, when executed by an apparatus, make the apparatus to execute the following operation:
obtaining a URL to be identified;
obtaining, based on the URL to be identified, a legitimate URL corresponding to the URL to be identified as a comparison object;
calculating a degree of similarity between the URL to be identified and the comparison object;
identifying the legitimacy of the URL to be identified based on the degree of similarity.

9. The nonvolatile computer storage medium according to claim 8, wherein the operation of obtaining, based on the URL to be identified, a legitimate URL corresponding to the URL to be identified as a comparison object comprises:
obtaining, based on the URL to be identified and an inverted index of legitimate URLs, a legitimate URL corresponding to the URL to be identified as the comparison object.

10. The nonvolatile computer storage medium according to claim 9, wherein, before the operation of obtaining, based on the URL to be identified and an inverted index of legitimate URLs, a legitimate URL corresponding to the URL to be identified as the comparison object, the one or more programs make the apparatus to further execute the following operation:
collecting at least one legitimate URL;
carry out word segmentation on each of the legitimate URLs of the at least one legitimate URL with a N-Gram model, so as to obtain a segmentation result;
obtaining the inverted index of legitimate URLs based on each of the legitimate URLs and the segmentation result of each of the legitimate URLs.

11. The nonvolatile computer storage medium according to claim 10, wherein the operation of carrying out a word segmentation on each of the legitimate URLs of the at least one legitimate URL with a N-Gram model, so as to obtain a segmentation result comprises:
obtaining the domain name of each of the legitimate URLs based each of the legitimate URLs;
removing the prefix and suffix of the domain name of each of the legitimate URLs, so as to obtain an essential word of each of the legitimate URLs;
carrying out word segmentation on the essential word of each of the legitimate URLs with a N-Gram model, so as to obtain a segmentation result.

12. The nonvolatile computer storage medium according to claim 8, wherein, the operation of identifying the legitimacy of the URL to be identified based on the degree of similarity comprises:
identifying the URL to be identified as a legitimate URL if the degree of similarity is equal to 1 and the suffix of the URL to be identified is consistent with the suffix of the comparison object; or
identifying the URL to be identified as a suspected illegitimate URL if the degree of similarity is equal to 1 and the suffix of the URL to be identified is inconsistent with the suffix of the comparison object; or
identifying the URL to be identified as an illegitimate URL if the degree of similarity is greater than or equal to a first threshold value and less than 1;
identifying the URL to be identified as a suspected illegitimate URL if the degree of similarity is greater than or equal to a second threshold value and less than the first threshold value, wherein the second threshold value is less than the first threshold value;
identifying the URL to be identified as a legitimate URL if the degree of similarity is less than the second threshold value or equal to 1.

13. The nonvolatile computer storage medium according to claim 12, wherein, before the operation of identifying the legitimacy of the URL to be identified based on the degree of similarity, the one or more programs make the apparatus to further execute the following operation:
carrying out legitimacy identification processing on at least one sample URL with the at least one legitimate URL, so as to obtain an identification result;
obtaining the first threshold value and the second threshold value based on the identification result and a labeling result of each of the sample URLs of the at least one sample URL.

14. The nonvolatile computer storage medium according to claim 8, wherein after the operation of identifying the legitimacy of the URL to be identified based on the degree of similarity, the one or more programs make the apparatus to further execute the following operation:
sending the identification result to a terminal so that:
the terminal displays the identification result; and/or
the terminal allows or prohibits, based on the identification result, executing access operations based on the URL to be identified.

15. An apparatus, comprising:
one or more processors;
a memory;
one or more programs, which are stored in the memory, and execute the following operation, when executed by the one or more processors:
obtaining a URL to be identified;
obtaining, based on the URL to be identified, a legitimate URL corresponding to the URL to be identified as a comparison object;
calculating a degree of similarity between the URL to be identified and the comparison object;
identifying the legitimacy of the URL to be identified based on the degree of similarity.

16. The apparatus according to claim 15, wherein the operation of obtaining, based on the URL to be identified, a legitimate URL corresponding to the URL to be identified as a comparison object comprises:
obtaining, based on the URL to be identified and an inverted index of legitimate URLs, a legitimate URL corresponding to the URL to be identified as the comparison object.

17. The apparatus according to claim 16, wherein, before the operation of obtaining, based on the URL to be identified and an inverted index of legitimate URLs, a legitimate URL corresponding to the URL to be identified as the comparison object, the one or more programs execute the following operation:
collecting at least one legitimate URL;
carry out word segmentation on each of the legitimate URLs of the at least one legitimate URL with a N-Gram model, so as to obtain a segmentation result;
obtaining the inverted index of legitimate URLs based on each of the legitimate URLs and the segmentation result of each of the legitimate URLs.

18. The apparatus according to claim 17, wherein the operation of carrying out a word segmentation on each of the legitimate URLs of the at least one legitimate URL with a N-Gram model, so as to obtain a segmentation result comprises:
obtaining the domain name of each of the legitimate URLs based each of the legitimate URLs;
removing the prefix and suffix of the domain name of each of the legitimate URLs, so as to obtain an essential word of each of the legitimate URLs;
carrying out word segmentation on the essential word of each of the legitimate URLs with a N-Gram model, so as to obtain a segmentation result.

19. The apparatus according to claim 15, wherein, the operation of identifying the legitimacy of the URL to be identified based on the degree of similarity comprises:
identifying the URL to be identified as a legitimate URL if the degree of similarity is equal to 1 and the suffix of the URL to be identified is consistent with the suffix of the comparison object; or
identifying the URL to be identified as a suspected illegitimate URL if the degree of similarity is equal to 1 and the suffix of the URL to be identified is inconsistent with the suffix of the comparison object; or
identifying the URL to be identified as an illegitimate URL if the degree of similarity is greater than or equal to a first threshold value and less than 1;
identifying the URL to be identified as a suspected illegitimate URL if the degree of similarity is greater than or equal to a second threshold value and less than the first threshold value, wherein the second threshold value is less than the first threshold value;
identifying the URL to be identified as a legitimate URL if the degree of similarity is less than the second threshold value or equal to 1.

20. The apparatus according to claim 19, wherein, before the operation of identifying the legitimacy of the URL to be identified based on the degree of similarity, the one or more programs further execute the following operation:
carrying out legitimacy identification processing on at least one sample URL with the at least one legitimate URL, so as to obtain an identification result;
obtaining the first threshold value and the second threshold value based on the identification result and a labeling result of each of the sample URLs of the at least one sample URL.

21. The apparatus according to claim 15, wherein after the operation of identifying the legitimacy of the URL to be identified based on the degree of similarity, the one or more programs further execute the following operation:
sending the identification result to a terminal so that:
the terminal displays the identification result; and/or
the terminal allows or prohibits, based on the identification result, executing access operations based on the URL to be identified.
